(19) United States
(12) Patent Application Publication
(10) Pub. No.: US 2011/0159293 A1
(43) Pub. Date: Jun. 30, 2011

(54) Polycarbonate Resin Composition and Molded Product Using the Same

(75) Inventors: Jung-Eun Park, Uiwang-si (KR); Doo-Han Ha, Uiwang-si (KR)

(73) Assignee: CHEIL INDUSTRIES INC., Gumi-si (KR)

(21) Appl. No.: 12/980,753

(22) Filed: Dec. 29, 2010

(30) Foreign Application Priority Data
Dec. 31, 2009 (KR) 10-2009-0136180
Dec. 22, 2010 (KR) 10-2010-0132659

(51) Int. Cl. C08L 55/02; C08L 51/00; B32B 27/06

(52) U.S. Cl. 428/412; 525/66; 524/504

(57) ABSTRACT

Disclosed is a polycarbonate resin composition that includes (A) a polycarbonate resin, (B) a rubber modified vinyl-based graft copolymer including a rubbery polymer having an average particle diameter of about 0.05 to about 0.5 μm, and (C) a rubber modified vinyl-based copolymer including a rubber-phase particle having an average particle diameter of about 0.6 to about 10 μm as a dispersion phase. A molded product using the polycarbonate resin composition is also provided.

### CROSS-REFERENCE TO RELATED APPLICATIONS

This application claims priority to and the benefit of Korean Patent Application Nos. 10-2009-0136180 and 10-2010-0132659 filed in the Korean Intellectual Property Office on Dec. 31, 2009, and Dec. 22, 2010, the entire disclosures of which are incorporated herein by reference.

### FIELD OF THE INVENTION

The present invention relates to a polycarbonate resin composition and a molded product made using the same.

### BACKGROUND OF THE INVENTION

Metal plated plastic articles can exhibit various properties similar to metal, such as a metal-like appearance, decorative properties, and the like. Metal plated plastic articles can also exhibit improved strength, abrasion resistance, heat resistance, water resistance, and the like. In an exemplary plastic plating method, acrylonitrile-butadiene-styrene (ABS) copolymer resin is treated with chromic acid and sulfuric acid prior to metal plating to improve the adhesiveness of the metal to the resin surface.

The acrylonitrile-butadiene-styrene (ABS) copolymer resin can be blended with a small amount of polycarbonate resin to provide impact and heat resistance properties. The ABS copolymer resin is dissolved and forms an anchor hole during the etching process, which promotes plating adhesion. However, as the amount of the polycarbonate resin increases and the amount of the ABS copolymer resin decreases, insufficient etching and deteriorated plating adhesion can result.

### SUMMARY

The present invention provides a polycarbonate resin composition that can have excellent plating adhesion as well as excellent impact resistance, heat resistance, and the like.

The present invention also provides a molded product made using the polycarbonate resin composition.

The polycarbonate resin composition includes (A) a polycarbonate resin, (B) a rubber modified vinyl-based graft copolymer including a rubbery polymer having an average particle diameter of about 0.05 to about 0.5 μm, and (C) a rubber modified vinyl-based copolymer including a rubber-phase particle having an average particle diameter of about 0.6 to about 10 μm as a dispersion phase.

The polycarbonate resin composition may include about 50 to about 90 wt % of the polycarbonate resin (A); about 5 to about 30 wt % of the rubber modified vinyl-based graft copolymer (B); and about 5 to about 20 wt % of the rubber modified vinyl-based copolymer including the rubber-phase particle as a dispersion phase (C). The rubber modified vinyl-based graft copolymer (B) may include a copolymer including about 30 to about 60 wt % a vinyl-based polymer grafted into about 40 to about 70 wt % of a rubbery polymer. The vinyl-based polymer of the rubber modified vinyl-based graft copolymer (B) may include about 70 to about 80 wt % of an aromatic vinyl compound and about 20 to about 30 wt % of a vinyl cyanide compound. The rubber modified vinyl-based graft copolymer (B) may include the vinyl cyanide compound in an amount of about 5 to about 20 wt % based on the total weight of the rubber modified vinyl-based graft copolymer (B).

The rubber modified vinyl-based graft copolymer (B) may be prepared using emulsion polymerization, suspension polymerization, bulk polymerization, or a combination thereof.

The rubber modified vinyl-based copolymer (C) may include a copolymer including a vinyl-based polymer occluded inside the rubber-phase particle, and the rubber modified vinyl-based copolymer (C) may include about 5 to about 30 wt % of the rubber-phase particle and about 70 to about 95 wt % of the vinyl-based polymer. The vinyl-based polymer of the rubber modified vinyl-based copolymer (C) may include an aromatic vinyl compound, a vinyl cyanide compound, a copolymer of an aromatic vinyl compound and a vinyl cyanide compound, or a combination thereof, and include about 60 to 90 wt % of the aromatic vinyl compound and about 10 to about 40 wt % of the vinyl cyanide compound. The rubber modified vinyl-based copolymer (C) may include the vinyl cyanide compound in an amount of about 5 to about 40 wt % based on the total weight of the rubber modified vinyl-based copolymer (C).

The rubber-phase particle may have an average particle diameter of about 0.6 to about 10 μm, for example about 0.6 to about 3 μm.

The rubber modified vinyl-based copolymer (C) may be prepared using continuous bulk polymerization, continuous solution polymerization, or a combination thereof.

The rubber modified vinyl-based graft copolymer (B) and the rubber modified vinyl-based copolymer (C) may be present at a weight ratio of about 1:6 to 6:1.

The polycarbonate resin composition may further include one or more additives such as an antibacterial agent, a heat stabilizer, an antioxidant, a release agent, a light stabilizer, a surfactant, a coupling agent, a plasticizer, an admixture, a colorant, a stabilizer, a lubricant, an antistatic agent, a coloring aid, a flame proofing agent, a weather-resistance agent, an ultraviolet (UV) absorber, an ultraviolet (UV) blocking agent, or a combination thereof.

The polycarbonate resin composition may have plating adhesion of about 800 g/cm or more.

The present invention further provides a molded product made using the polycarbonate resin composition.

Hereinafter, further embodiments will be described in detail.

The polycarbonate resin composition according to one embodiment can have good plating adhesion as well as excellent impact resistance, heat resistance, and the like. Thus, the polycarbonate resin composition may be used in various products such as electronic parts, automobile parts, miscellaneous parts, and the like, which require a metal-like texture, impact resistance, heat resistance, and the like.

### DETAILED DESCRIPTION

The present invention will be described more fully hereinafter in the following detailed description of the invention, in which some but not all embodiments of the invention are described. Indeed, this invention may be embodied in many different forms and should not be construed as limited to the embodiments set forth herein; rather, these embodiments are provided so that this disclosure will satisfy applicable legal requirements.

As used herein, when a specific definition is not otherwise provided, the term “substituted” refers to one substituted with at least one substituent including a halogen (F, Cl, Br, I), a hydroxy group, a nitro group, cyano group, an amino group, an azido group, an amidino group, a hydrazino group, a hydrazono group, a carbonyl group, a carbamyl group, a thiol group, an ester group, a carboxyl group or a salt thereof, sulfonic acid group or a salt thereof, phosphoric acid group or a salt thereof, a C1 to C20 alkyl group, a C2 to C20 alkenyl group, a C2 to C20 alkynyl group, a C1 to C20 alkoxy group, a C6 to C30 aryl group, a C6 to C30 aryloxy group, a C3 to C30 cycloalkyl group, a C3 to C30 cycloalkenyl group, a C3 to C30 cycloalkynyl group, or a combination thereof, in place of hydrogen.

The polycarbonate resin composition according to one embodiment includes (A) a polycarbonate resin, (B) a rubber modified vinyl-based graft copolymer including a rubbery polymer having an average particle diameter of about 0.05 to about 0.5 μm, and (C) a rubber modified vinyl-based copolymer including a rubber-phase particle having an average particle diameter of about 0.6 to about 10 μm as a dispersion phase.

Exemplary components included in the polycarbonate resin composition according to embodiments will hereinafter be described in detail.

(A) Polycarbonate Resin

The polycarbonate resin may be prepared by reacting one or more diphenols of the following Chemical Formula I with a compound of phosgene, halogen acid ester, carbonate ester, or a combination thereof.

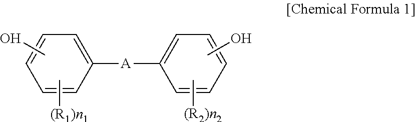

In Chemical Formula I,

A is a single bond, substituted or unsubstituted C1 to C30 linear or branched alkylene, substituted or unsubstituted C2 to C5 alkenylene, substituted or unsubstituted C2 to C5 alkylidene, substituted or unsubstituted C1 to C30 linear or branched haloalkylene, substituted or unsubstituted C5 to C6 cycloalkylene, substituted or unsubstituted C5 to C6 cycloalkenylene, substituted or unsubstituted C5 to C10 cycloalkylidene, substituted or unsubstituted C6 to C30 arylene, substituted or unsubstituted C1 to C20 linear or branched alkoxylene, halogen acid ester, carbonate ester, CO, S, or SO₂,

each of R₁ and R₂ is independently substituted or unsubstituted C1 to C30 alkyl or substituted or unsubstituted C6 to C30 aryl, and

n₁ and n₂ are independently integers ranging from 0 to 4.

The diphenols represented by the above Chemical Formula I may be used singly or in combinations to constitute repeating units of the polycarbonate resin. Exemplary diphenols include without limitation 4,4′-dihydroxydiphenyl, 2,2-bis(4-hydroxyphenyl)propane (referred to as “bisphenol-A”), 2,4-bis(4-hydroxyphenyl)-2-methylbutane, bis(4-hydroxyphenyl)methane, 1,1-bis(4-hydroxyphenyl)cyclohexane, 2,2-bis(3-chloro-4-hydroxyphenyl)propane, 2,2-bis(3,5-dimethyl-4-hydroxyphenyl)propane, 2,2-bis(3,5-dichloro-4-hydroxyphenyl)propane, 2,2-bis(3,5-dibromo-4-hydroxyphenyl)propane, bis(4-hydroxyphenyl)sulfoxide, bis(4-hydroxyphenyl)ketone, bis(4-hydroxyphenyl)ether, and the like, and combinations thereof. In exemplary embodiments, the diphenol can include 2,2-bis(4-hydroxyphenyl)-propane, 2,2-bis(3,5-dichloro-4-hydroxyphenyl)-propane, or 1,1-bis(4-hydroxyphenyl)-cyclohexane. In other exemplary embodiments, the diphenol can include 2,2-bis(4-hydroxyphenyl)-propane.

In exemplary embodiments, the polycarbonate resin can have a weight average molecular weight ranging from about 10,000 to about 200,000 g/mol, for example about 15,000 to about 80,000 g/mol, but the molecular weight of the polycarbonate is not limited thereto.

The polycarbonate resin may include a mixture of polycarbonate resins obtained using two or more diphenols that are different from each other. The polycarbonate resin may also include a linear polycarbonate resin, a branched polycarbonate resin, a polyester carbonate copolymer, and the like, or a combination thereof.

The linear polycarbonate resin may include a bisphenol-A based polycarbonate resin. The branched polycarbonate resin may include one produced by reacting a multi-functional aromatic compound such as trimellitic anhydride, trimellitic acid, and the like with diphenols and a carbonate. The multi-functional aromatic compound may be included in an amount of 0.05 to 2 mol % based on the total weight of the branched polycarbonate resin. The polyester carbonate copolymer resin may include one produced by reacting a difunctional carboxylic acid with diphenols and a carbonate. The carbonate may include a diaryl carbonate such as diphenyl carbonate, and ethylene carbonate.

The polycarbonate resin composition of the invention may include the polycarbonate resin (A) in an amount of about 50 to about 90 wt %, for example about 60 to about 80 wt %, based on the total weight of the polycarbonate resin composition. In some embodiments, the polycarbonate resin composition of the invention may include the polycarbonate resin (A) in an amount of about 50, 51, 52, 53, 54, 55, 56, 57, 58, 59, 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, or 90 wt %. Further, according to some embodiments of the present invention, the amount of the polycarbonate resin (A) can be in a range from about any of the foregoing amounts to about any other of the foregoing amounts. When the polycarbonate resin is included in an amount within this range, the polycarbonate resin composition can have an improved balance of properties such as impact strength, heat resistance, and workability.

(B) Rubber Modified Vinyl-Based Graft Copolymer

The rubber modified vinyl-based graft copolymer (B) may be a copolymer of about 30 to about 60 wt % of a vinyl-based polymer grafted into about 40 to about 70 wt % of a rubbery polymer.

In some embodiments, the rubber modified vinyl-based graft copolymer (B) may include the vinyl-based polymer in an amount of about 30, 31, 32, 33, 34, 35, 36, 37, 38, 39, 40, 41, 42, 43, 44, 45, 46, 47, 48, 49, 50, 51, 52, 53, 54, 55, 56, 57, 58, 59, or 60 wt %. Further, according to some embodiments of the present invention, the amount of the vinyl-based polymer can be in a range from about any of the foregoing amounts to about any other of the foregoing amounts.

In some embodiments, the rubber modified vinyl-based graft copolymer (B) may include the rubbery polymer in an amount of about 40, 41, 42, 43, 44, 45, 46, 47, 48, 49, 50, 51, 52, 53, 54, 55, 56, 57, 58, 59, 60, 61, 62, 63, 64, 65, 66, 67, 68, 69, or 70 wt %. Further, according to some embodiments of the present invention, the amount of the rubbery polymer can be in a range from about any of the foregoing amounts to about any other of the foregoing amounts.

The vinyl-based polymer of the rubber modified vinyl-based graft copolymer (B) may include about 70 to about 80 wt % of an aromatic vinyl compound and about 20 to about 30 wt % of a vinyl cyanide compound.

In some embodiments, the vinyl-based polymer of the rubber modified vinyl-based graft copolymer (B) may include the aromatic vinyl compound in an amount of about 70, 71, 72, 73, 74, 75, 76, 77, 78, 79, or 80 wt %. Further, according to some embodiments of the present invention, the amount of the aromatic vinyl compound can be in a range from about any of the foregoing amounts to about any other of the foregoing amounts.

In some embodiments, the vinyl-based polymer of the rubber modified vinyl-based graft copolymer (B) may include the vinyl cyanide compound in an amount of about 20, 21, 22, 23, 24, 25, 26, 27, 28, 29, or 30 wt %. Further, according to some embodiments of the present invention, the amount of the vinyl cyanide compound can be in a range from about any of the foregoing amounts to about any other of the foregoing amounts.

Examples of the aromatic vinyl compounds may include without limitation styrene, C1 to C10 alkyl substituted styrene, halogen substituted styrene, and the like, and combination thereofs. Examples of the alkyl substituted styrene may include without limitation o-ethyl styrene, m-ethyl styrene, p-ethyl styrene, α-methyl styrene, and the like, and combinations thereof.

Examples of the vinyl cyanide compound may include without limitation acrylonitrile, methacrylonitrile, ethacrylonitrile, and the like, and combinations thereof.

The rubber modified vinyl-based graft copolymer (B) can include the vinyl cyanide compound in an amount of about 5 to about 20 wt %, for example about 5 to about 15 wt %, based on the total weight of the rubber modified vinyl-based graft copolymer. In some embodiments, the rubber modified vinyl-based graft copolymer (B) may include the vinyl cyanide compound in an amount of about 5, 6, 7, 8, 9, 10, 11, 12, 13, 14, 15, 16, 17, 18, 19, or 20 wt %. Further, according to some embodiments of the present invention, the amount of the vinyl cyanide compound can be in a range from about any of the foregoing amounts to about any other of the foregoing amounts.

When the rubber modified vinyl-based graft copolymer (B) includes the vinyl cyanide compound in an amount within this range, excellent impact resistance and heat resistance, and improved plating adhesion may be obtained.

Examples of the rubbery polymer may include without limitation butadiene rubbers, acrylic rubbers, ethylene/propylene rubbers, styrene/butadiene rubbers, acrylonitrile/butadiene rubbers, isoprene rubbers, ethylene-propylene-diene terpolymer (EPDM) rubbers, polyorganosiloxane/polyalkyl(meth)acrylate rubber composites, and the like, and combinations thereof.

The rubbery polymer may have an average particle diameter of about 0.05 to about 0.5 μm, for example about 0.1 to about 0.4 μm. In some embodiments, the rubbery polymer may have an average particle diameter of about 0.05, 0.06, 0.07, 0.08, 0.09, 0.1, 0.2, 0.3, 0.4, or 0.5 μm. Further, according to some embodiments of the present invention, the average particle diameter of the rubbery polymer can be in a range from about any of the foregoing sizes to about any other of the foregoing sizes. When the rubbery polymer has an average particle diameter within this range, excellent impact resistance may be secured.

The rubber modified vinyl-based graft copolymer may be prepared by emulsion polymerization, suspension polymerization, bulk polymerization, or a combination thereof.

The polycarbonate resin composition may include the rubber modified vinyl-based graft copolymer (B) in an amount of about 5 to about 30 wt %, for example about 10 to 20 wt %, based on the total weight of the polycarbonate resin composition. In some embodiments, the polycarbonate resin composition of the invention may include the rubber modified vinyl-based graft copolymer (B) in an amount of about 5, 6, 7, 8, 9, 10, 11, 12, 13, 14, 15, 16, 17, 18, 19, 20, 21, 22, 23, 24, 25, 26, 27, 28, 29, or 30 wt %. Further, according to some embodiments of the present invention, the amount of the rubber modified vinyl-based graft copolymer (B) can be in a range from about any of the foregoing amounts to about any other of the foregoing amounts. When the rubber modified vinyl-based graft copolymer is included in an amount within this range, excellent impact resistance and heat resistance as well as improved plating adhesion may be secured.

(C) Rubber Modified Vinyl-based Copolymer

The rubber modified vinyl-based copolymer (C) may include a copolymer including a vinyl-based polymer occluded inside the rubber-phase particle. The rubber modified vinyl-based copolymer (C) may include about 5 to about 30 wt % of the rubber-phase particle and about 70 to about 95 wt % of the vinyl-based polymer.

In some embodiments, the rubber modified vinyl-based copolymer (C) may include the vinyl-based polymer in an amount of about 70, 71, 72, 73, 74, 75, 76, 77, 78, 79, 80, 81, 82, 83, 84, 85, 86, 87, 88, 89, 90, 91, 92, 93, 94, or 95 wt %. Further, according to some embodiments of the present invention, the amount of the vinyl-based polymer can be in a range from about any of the foregoing amounts to about any other of the foregoing amounts.

In some embodiments, the rubber modified vinyl-based copolymer (C) may include the rubber-phase particle in an amount of about 5, 6, 7, 8, 9, 10, 11, 12, 13, 14, 15, 16, 17, 18, 19, 20, 21, 22, 23, 24, 25, 26, 27, 28, 29, or 30 wt %. Further, according to some embodiments of the present invention, the amount of the rubber-phase particle can be in a range from about any of the foregoing amounts to about any other of the foregoing amounts.

The vinyl-based polymer of the rubber modified vinyl-based copolymer (C) may include an aromatic vinyl compound, a vinyl cyanide compound, a copolymer of an aromatic vinyl compound and a vinyl cyanide compound, or a combination thereof. The vinyl-based polymer of the rubber modified vinyl-based copolymer (C) may include a mixture of the aromatic vinyl compound and vinyl cyanide compound. The vinyl-based polymer of the rubber modified vinyl-based copolymer (C) may include about 60 to about 90 wt % of the aromatic vinyl compound and about 10 to about 40 wt % of the vinyl cyanide compound.

In some embodiments, the vinyl-based polymer of the rubber modified vinyl-based copolymer (C) may include the aromatic vinyl compound in an amount of about 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, or 90 wt %. Further, according to some embodiments of the present invention, the amount of the aromatic vinyl compound can be in a range from about any of the foregoing amounts to about any other of the foregoing amounts.

In some embodiments, the vinyl-based polymer of the rubber modified vinyl-based copolymer (C) may include the vinyl cyanide compound in an amount of about 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, or 40 wt %. Further, according to some embodiments of the present invention, the amount of the vinyl cyanide compound can be in a range from about any of the foregoing amounts to about any other of the foregoing amounts.

Examples of the aromatic vinyl compound may include without limitation styrene, C1 to C10 alkyl substituted styrene, halogen substituted styrene, and the like, and combinations thereof. Examples of the alkyl substituted styrene may include without limitation o-ethyl styrene, m-ethyl styrene, p-ethyl styrene, α-methyl styrene, and the like, and combinations thereof. Examples of the vinyl cyanide compound may include without limitation acrylonitrile, methacrylonitrile, ethacrylonitrile, and the like, and combinations thereof.

The rubber modified vinyl-based copolymer (C) may include the vinyl cyanide compound in an amount of about 5 to about 40 wt %, for example about 10 to about 25 wt %, based on the total weight of the rubber modified vinyl-based copolymer (C). In some embodiments, the rubber modified vinyl-based copolymer (C) may include the vinyl cyanide compound in an amount of about 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, or 40 wt %. Further, according to some embodiments of the present invention, the amount of the vinyl cyanide compound can be in a range from about any of the foregoing amounts to about any other of the foregoing amounts.

When the vinyl cyanide compound is included in the rubber modified vinyl-based copolymer (C) in an amount within this range, excellent etching property and plating adhesion may be secured.

The rubber modified vinyl-based copolymer (C) may include a rubber-phase particle as a dispersion phase.

Examples of the rubber-phase particle may include without limitation butadiene rubbers, acrylic rubbers, ethylene/propylene rubbers, styrene/butadiene rubbers, acrylonitrile/butadiene rubbers, isoprene rubbers, ethylene-propylene-diene terpolymer (EPDM) rubbers, polyorganosiloxane/polyalkyl(meth)acrylate rubber composites, and the like, and combinations thereof.

The rubber-phase particle may have an average particle diameter of about 0.6 to about 10 μm, for example about 0.6 to about 3 μm. In some embodiments, the rubber-phase particle may have an average particle diameter of about 0.6, 0.7, 0.8, 0.9, 1, 2, 3, 4, 5, 6, 7, 8, 9, or 10 μm. Further, according to some embodiments of the present invention, the average particle diameter of the rubber-phase particle can be in a range from about any of the foregoing sizes to about any other of the foregoing sizes. When the rubber-phase particle has an average particle diameter within the range, excellent plating adhesion may be secured.

The rubber modified vinyl-based copolymer (C) may be prepared using continuous bulk polymerization, continuous solution polymerization, or a combination thereof.

The polycarbonate resin composition may include the rubber modified vinyl-based copolymer (C) in an amount of about 5 to about 20 wt %, for example about 5 to about 15 wt %, based on the total weight of the polycarbonate resin composition. In some embodiments, the polycarbonate resin composition may include the rubber modified vinyl-based copolymer (C) in an amount of about 5, 6, 7, 8, 9, 10, 11, 12, 13, 14, 15, 16, 17, 18, 19, or 20 wt %. Further, according to some embodiments of the present invention, the amount of the rubber modified vinyl-based copolymer (C) can be in a range from about any of the foregoing amounts to about any other of the foregoing amounts.

When the polycarbonate resin composition includes the rubber modified vinyl-based copolymer (C) in an amount within this range, excellent impact resistance and heat resistance may be obtained and plating adhesion may be improved.

The rubber modified vinyl-based graft copolymer (B) and the rubber modified vinyl-based copolymer (C) may be present at a weight ratio of about 1:6 to 6:1, for example about 1:4 to about 4:1. When they are present at this weight ratio, excellent impact resistance, heat resistance and plating adhesion may be obtained.

The polycarbonate resin composition may further include one or more additives, such as but not limited to an antibacterial agent, a heat stabilizer, an antioxidant, a release agent, a light stabilizer, a surfactant, a coupling agent, a plasticizer, an admixture, a colorant, a stabilizer, a lubricant, an antistatic agent, a coloring aid, a flame proofing agent, a weather-resistance agent, an ultraviolet (UV) absorber, an ultraviolet (UV) blocking agent, or a combination thereof.

Examples of the antioxidant may include without limitation phenol based antioxidants, phosphite based antioxidants, thioether based antioxidants, amine based antioxidants, and the like, and combinations thereof. Examples of the release agent may include without limitation fluoropolymers, silicon oils, metal salts of stearic acid, metal salts of montanic acid, montanic ester waxes, polyethylene waxes, and the like, and combinations thereof. Examples of the weather-resistance agent may include without limitation benzophenone-type weather-resistance agents, amine-type weather-resistance agents, and the like, and combinations thereof. Examples of the colorant may include without limitation dyes, pigments, and the like, and combinations thereof. Examples of the ultraviolet (UV) ray blocking agent may include without limitation titanium oxide (TiO₂), carbon black, and the like, and combinations thereof.

The additive may be included in a predetermined amount as long as it does not deteriorate the properties of the polycarbonate resin composition. In exemplary embodiments, the additive(s) may be included in an amount of about 25 parts by weight or less, for example about 0.1 to about 15 parts by weight, based on 100 parts by weight of the polycarbonate resin composition.

The polycarbonate resin composition of the invention can be used in a plating process, without any particular limitation. An exemplary plating process is described below.

A specimen of the polycarbonate resin composition of the invention is treated with a surfactant under predetermined temperature and time conditions to remove oil and then the specimen is treated with an anhydrous chromic acid-sulfuric acid as an etching agent under predetermined temperature and time conditions to oxidize the rubbery polymer of the rubber-modified vinyl-based graft copolymer (B) and/or the rubber-phase particle of the rubber-modified vinyl-based copolymer (C). Next, the resulting product is treated with a hydrochloric acid aqueous solution under predetermined temperature and time conditions to remove remaining chromic acid and then is treated with a palladium-tin catalyst under predetermined temperature and time conditions to absorb palladium into the anchor holes. Then, the aforementioned catalyst may be activated by using a sulfuric acid aqueous solution under predetermined temperature and time conditions to remove tin and then, electroless plated under predetermined temperature and time conditions using nickel sulfate. After the electroless plating, the product is electroplated under predetermined temperature, time, and current conditions using copper, nickel, and chromium.

The polycarbonate resin composition may have a plating adhesion of about 800 g/cm or more. The plating adhesion indicates the strength of adhesion of the metal plated layer to the resin article. The plating adhesion can be measured by peeling a 10 mm wide portion of the plated metal from the surface of the polycarbonate resin article about 80 mm in a vertical direction using a pull gage. When the polycarbonate resin composition has a plating adhesion within the aforementioned range, it may have excellent plating properties and the plated article may have an excellent metal-like appearance.

The polycarbonate resin composition may be prepared using well-known methods for preparing a resin composition. For example, the components can be mixed together, optionally with one or more additives. The mixture can be melt-extruded and prepared into pellet form, which can be subsequently processed to form a molded product. Alternatively, the mixture can be directly melt-extruded to form a molded product.

According to another embodiment, the aforementioned polycarbonate resin composition is molded to provide a molded product. In other words, the polycarbonate resin composition is used to manufacture a molded product using various processes such as injection molding, blow molding, extrusion molding, thermal molding, and the like. In exemplary embodiments, the polycarbonate resin composition may be used in the productions of various electronic parts, automobile parts, miscellaneous parts, and the like, which need excellent impact resistance, heat resistance, and the like.

The following examples illustrate this disclosure in more detail. However, it is understood that this disclosure is not limited by these examples.

A polycarbonate resin composition according to one embodiment includes each component as follows.

(A) Polycarbonate Resin

(A-1) A polycarbonate resin with a weight average molecular weight of about 28,000 available from Cheil Industries under the name SC-1080 is used.

(A-2) A polycarbonate resin with a weight average molecular weight of about 23,000 available from Cheil Industries under the nameSC-1190 is used.

(B) Rubber Modified Vinyl-Based Graft Copolymer

g-ABS is prepared by emulsion-graft polymerizing 60 parts by weight of butadiene rubber with an average particle diameter of 0.27 μm and 40 parts by weight of a vinyl-based polymer including 75 wt % of styrene and 25 wt % of acrylonitrile.

(C) Rubber Modified Vinyl-Based Copolymer

(C-1) C-ABS is prepared by continuous solution-polymerizing 15 wt % of a rubber-phase particle of butadiene with an average particle diameter of about 1 μm and 85 wt % of a vinyl-based polymer including 85 wt % of styrene and 15 wt % of acrylonitrile using a conventional method.

(C-2) C-ABS is prepared by continuous solution-polymerizing 20 wt % of a rubber-phase particle of butadiene with an average particle diameter of 15 μm and 80 wt % of a vinyl-based polymer including 85 wt % of styrene and 15 wt % of acrylonitrile using a conventional method.

(D) Vinyl-Based Copolymer

A SAN resin with a weight average molecular weight of about 150,000 and including 76 wt % of styrene and 24 wt % of acrylonitrile is used as a vinyl-based copolymer in the Comparative Example.

### Examples 1 to 4 and Comparative Examples 1 to 4

Each polycarbonate resin composition according to Examples 1 to 4 and Comparative Examples 1 to 4 is prepared using the aforementioned components in the amounts provided in the following Table 1.

The components are mixed, extruded in a conventional twin-screw extruder, and then shaped into pellets.

### Experimental Examples

The pellets are dried at 100° C. for 2 hours and injection-molded by using a 6 oz injection molding machine set a cylinder temperature at 260° C., a molding temperature at 60° C., and a shaping cycle time of 30 seconds, to prepare a specimen for evaluating various properties according to ATSM standards.

The specimens (152.4 mm×152.4 mm×3 mm) are respectively plated. The plating process is as follows.

First, the specimens are treated with a surfactant at 55° C. for 5 minutes to remove oil and then treated with anhydrous chromic acid-sulfuric acid as an etching agent to oxidize butadiene at 65° C. for 15 minutes. Then, the resulting product is treated with a hydrochloric acid aqueous solution at 25° C. for 25 seconds to remove remaining chromic acid and then treated with a palladium-tin catalyst at 30° C. for 2 minutes to absorb palladium into the anchor holes. Next, the catalyst is activated at 55° C. for 2 minutes to remove tin using an aqueous sulfuric acid solution and then, the specimen is electroless plated at 30° C. for 5 minutes using nickel sulfate. Then, the resulting product is electroplated using copper, nickel, and chromium. In particular, the product is copper-electroplated at 25° C. for 35 minutes with 3 A/dm² using copper sulfate. The nickel-electroplating is performed using nickel sulfate at 55° C. for 15 minutes with 3 A/dm². The chromium-electroplating is performed using anhydrous chromic acid at 55° C. for 3 minutes with 15 A/dm². The plating layer may include a copper plating layer ranging from 25 to 27 μm, a nickel plating layer ranging from 10 to 11 μm, and a chromium plating layer ranging from 0.4 to 0.5 μm and thus, have a thickness ranging from 36 to 38 μm in total.

Properties of the plated specimens are measured using the following methods. The results are provided in the following Table 1.

(1) IZOD impact strength: measured according to ASTM D256 (a specimen thickness of ⅛″).

(2) Thermal distortion temperature: measured according to ASTM D648.

(3) Pitting: a specimen is examined for defects generated after the plating with the naked eye.

(4) Plating adhesion: The force required to peel a 10 mm wide portion of the metal plating on the front side of the resin article about 80 mm in a vertical direction using a pull gage is measured to determine the strength of plating adhesion. The result is expressed in units of g/cm. The test is performed three times per specimen. Then, the average of the three tests is acquired.

TABLE 1

| | | Examples | | | | Comparative Examples | | | |
|---|---|---|---|---|---|---|---|---|---|
| | | 1 | 2 | 3 | 4 | 1 | 2 | 3 | 4 |
| (A) Polycarbonate resin (wt %) | A-1 | 23 | 25 | 30 | 20 | 23 | 23 | 23 | 25 |
| | A-2 | 52 | 55 | 50 | 55 | 52 | 52 | 52 | 50 |
| (B) Rubber modified vinyl-based | | 10 | 10 | 15 | 5 | 15 | — | — | 10 |
| graft copolymer (wt %) | | | | | | | | | |
| (C) Rubber modified vinyl- | C-1 | 15 | 10 | 5 | 20 | — | 25 | 15 | — |
| based copolymer (wt %) | C-2 | — | — | — | — | — | — | 10 | 15 |

| | | | | | | | | |
|---|---|---|---|---|---|---|---|---|
| (D) Vinyl-based copolymer (wt %) | — | — | — | — | 10 | — | — | — |
| Impact strength (kgf · cm/cm) | 58 | 63 | 65 | 60 | 54 | 30 | 32 | 40 |
| Thermal distortion temperature (° C.) | 120 | 125 | 115 | 118 | 116 | 121 | 119 | 115 |
| Pit (number) | 6 | 8 | 6 | 5 | 7 | 9 | 1 | 20 |
| Plating adhesion (g/cm) | 800 | 1030 | 950 | 1010 | 450 | 900 | 1250 | 850 |

Referring to Table 1, the polycarbonate resin compositions of Examples 1 to 4, which include a polycarbonate resin (A), a rubber modified vinyl-based graft copolymer (B) including a rubbery polymer having an average particle diameter of about 0.05 to about 0.5 μm, and a rubber modified vinyl-based copolymer (C) including a rubber-phase particle having an average particle diameter of about 0.6 to about 10 μm as a dispersion phase, exhibit excellent impact and heat resistances and good plating adhesion, as compared to the compositions of Comparative Example 1, which does not include rubber modified vinyl-based copolymer (C) but does include a vinyl-based copolymer (D); Comparative Example 2, which does not include a rubber modified vinyl-based graft copolymer (B); Comparative Example 3, which does not include a rubber modified vinyl-based graft copolymer (B) and includes a rubber modified vinyl-based copolymer (C) having a rubber-phase particle size outside of the average particle diameter of the invention; and Comparative Example 4, which includes a rubber modified vinyl-based copolymer (C) having a rubber-phase particle size outside of the average particle diameter of the invention.

In addition, as shown in Examples 1 to 4, the polycarbonate resin composition exhibits excellent plating adhesion despite a large amount of a polycarbonate resin.

Many modifications and other embodiments of the invention will come to mind to one skilled in the art to which this invention pertains having the benefit of the teachings presented in the foregoing description. Therefore, it is to be understood that the invention is not to be limited to the specific embodiments disclosed and that modifications and other embodiments are intended to be included within the scope of the appended claims. Although specific terms are employed herein, they are used in a generic and descriptive sense only and not for purposes of limitation, the scope of the invention being defined in the claims.

What is claimed is:

1. A polycarbonate resin composition, comprising:
(A) a polycarbonate resin;
(B) a rubber modified vinyl-based graft copolymer including a rubbery polymer having an average particle diameter of about 0.05 to about 0.5 μm; and
(C) a rubber modified vinyl-based copolymer including a rubber-phase particle having an average particle diameter of about 0.6 to about 10 μm as a dispersion phase.

2. The polycarbonate resin composition of claim 1, wherein the polycarbonate resin composition comprises:
about 50 to about 90 wt % of the polycarbonate resin (A);
about 5 to about 30 wt % of the rubber modified vinyl-based graft copolymer (B); and
about 5 to about 20 wt % of the rubber modified vinyl-based copolymer including the rubber-phase particle as a dispersion phase (C).

3. The polycarbonate resin composition of claim 1, wherein the rubber modified vinyl-based graft copolymer (B) comprises a copolymer including about 30 to about 60 wt % of a vinyl-based polymer grafted into about 40 to about 70 wt % of a rubbery polymer.

4. The polycarbonate resin composition of claim 1, wherein the rubber modified vinyl-based graft copolymer (B) is prepared using emulsion polymerization, suspension polymerization, bulk polymerization, or a combination thereof.

5. The polycarbonate resin composition of claim 3, wherein the vinyl-based polymer comprises about 70 to about 80 wt % of an aromatic vinyl compound and about 20 to about 30 wt % of a vinyl cyanide compound.

6. The polycarbonate resin composition of claim 5, wherein the rubber modified vinyl-based graft copolymer (B) includes the vinyl cyanide compound in an amount of about 5 to about 20 wt % based on the total weight of the rubber modified vinyl-based graft copolymer (B).

7. The polycarbonate resin composition of claim 1, wherein the rubber modified vinyl-based copolymer (C) comprises a copolymer including a vinyl-based polymer occluded inside the rubber-phase particle.

8. The polycarbonate resin composition of claim 7, wherein the rubber modified vinyl-based copolymer (C) comprises about 5 to about 30 wt % of the rubber-phase particle and about 70 to about 95 wt % of the vinyl-based polymer.

9. The polycarbonate resin composition of claim 7, wherein the vinyl-based polymer comprises an aromatic vinyl compound, a vinyl cyanide compound, a copolymer of an aromatic vinyl compound and a vinyl cyanide compound, or a combination thereof.

10. The polycarbonate resin composition of claim 7, wherein the vinyl-based polymer comprises about 60 to about 90 wt % of the aromatic vinyl compound and about 10 to about 40 wt % of the vinyl cyanide compound.

11. The polycarbonate resin composition of claim 9, wherein the rubber modified vinyl-based copolymer (C) includes the vinyl cyanide compound in an amount of about 5 to about 40 wt % based on the total weight of the rubber modified vinyl-based copolymer (C).

12. The polycarbonate resin composition of claim 1, wherein the rubber-phase particle has an average particle diameter of about 0.6 to about 3 μm.

13. The polycarbonate resin composition of claim 1, wherein the rubber modified vinyl-based copolymer (C) is prepared using continuous bulk polymerization, continuous solution polymerization, or a combination thereof.

14. The polycarbonate resin composition of claim 1, wherein the rubber modified vinyl-based graft copolymer (B) and the rubber modified vinyl-based copolymer (C) are present at a weight ratio of about 1:6 to 6:1.

15. The polycarbonate resin composition of claim 1, wherein the polycarbonate resin composition further comprises an additive including an antibacterial agent, a heat stabilizer, an antioxidant, a release agent, a light stabilizer, a surfactant, a coupling agent, a plasticizer, an admixture, a colorant, a stabilizer, a lubricant, an antistatic agent, a coloring aid, a flame proofing agent, a weather-resistance agent, an ultraviolet (UV) absorber, an ultraviolet (UV) blocking agent, or a combination thereof.

16. The polycarbonate resin composition of claim 1, wherein the polycarbonate resin composition has a plating adhesion of about 800 g/cm or more.

17. A molded product using the polycarbonate resin composition according to claim 1.

18. The molded product of claim 17, including a metal plated layer on a surface thereof.
